(19) United States
(12) Patent Application Publication
(10) Pub. No.: US 2006/0175158 A1
(43) Pub. Date: Aug. 10, 2006

(54) Railway wheel with integrated brake drum

(76) Inventor: Ming (Jason) Zhang, Montreal (CA)

Correspondence Address: Ming (Jason) Zhang, 5270 Rosedale Avenue, Montreal, QC, H4V 2H6, CA

(21) Appl. No.: 11/040,717

(22) Filed: Jan. 24, 2005

(51) Int. Cl. F16D 65/827

(52) U.S. Cl. 188/218 R

(57) ABSTRACT

The present invention provides novel railway wheel configurations with integrated brake drum dedicated to vehicle frictional braking, along with manufacturing method of the novel wheel and modification schemes for existing railway vehicle components. The novel wheel configurations with integrated brake drum enables increased thermal tolerances to brake shoe thermal input, enhanced resistances to varies thermal damages and reduced hot axial deflection.

### CROSS REFERENCE TO RELATED APPLICATIONS Not Available.

### TECHNICAL FIELD

The present invention relates generally to methods and apparatus for frictional braking of a vehicle or other heavy machinery. In particular, the present invention relates to novel railway wheel configuration that provides integrated brake drum dedicated to railway vehicle frictional braking.

### BACKGROUND OF THE INVENTION

Railway wheels mounted to freight car serves as not only a mechanical supporting component guiding rail car along the rail, but also a brake drum generating sufficient brake torque to stop the train and dissipating rapidly brake heat for safe train operation.

It has been recognized that railway wheels suffer from various types of wheel thermal damages due to brake heat produced in the tread and internal stresses of expansion (tensile) and contraction (compressive) developed in the wheel due to the brake heat, the wheel thermal damages including,
1. Thermal fatigue cracking on wheel tread surface due to localized stress reversal from the as-manufactured residual compressive hoop stress to tensile stresses;
2. Thermal failure due to, in wheel rim, complete reversal from beneficial compressive residual hoop stresses left by the manufacturing process to tensile stresses, and in wheel plate, development of strong tensile hoop stresses;
3. Thermal-mechanical shelling due to combined elevated tread temperature and high rolling contact stresses;
4. Wheel spalling resulted from fracture of brittle martensite, formed during wheel slides and being subjected to high wheel/rail rolling contact stresses;
5. Built up tread (out of round) due to thermal deformation of wheel that can induce high impact damages to wheel, wheel set, rail car and lading.

Recent studies also suggested that under heavier braking, brake heat, referring also as brake shoe thermal input, may accelerate the growth of shattered rim fracture, a phenomenon whereby rolling contact fatigue crack initiates at an internal defect in the wheel rim subsurface and propagates rapidly to cause a sudden substantial damage to the wheel.

Brake shoe thermal input also causes damaging hot axial deflection of wheel flange that could introduce large variations in rail/wheel flange clearances at elevated temperature and subsequent normal operation. Such variations could impair dynamic performance and safety of rail car under extreme service conditions.

Through predominately abrasive wear at high temperatures, wheel tread braking contributes to acceleration of uneven worn out of wheel tread and formation of hollow tread. The hollow tread can also induce high impact damages to wheel, rail, wheel set, rail car and lading and must be corrected by truing which shortens significantly normal wheel service life.

It can be easily noticed that the configuration of railway wheel of prior arts requires sharing of a single wheel tread surface by engaging-rail all the times and by engaging-brake-shoe during tread braking.

The direct brake shoe thermal input makes the wheel tread hottest region in the wheel while the rail/wheel rolling contacts or impacts make the same wheel tread highest stressed region in the wheel. Such overlap of high stress and high temperature and its combined effects make the wheel tread extremely vulnerable to the above-mentioned thermal wheel damages.

To obtain enough strength for reliable wheel performance, thick cross sectional wheel rim with heavy metal volume is provided in the prior arts, resulting in return, inefficient heat dissipation, rapid heat accumulation in wheel rim and rapid thermal stresses development in wheel rim/wheel plate, large hot axial deflection of wheel flange and large variation of wheel/rail clearances.

Despite all the above mentioned problems, wheel tread braking does offer a lot of advantages compared with alternative disc braking system and is widely used in various railway vehicles, the advantages including:
1. Simple, robust and low-cost brake system that can be easily maintained;
2. No additional brake disc or brake disc hub required, facilitating its application in space-limiting locomotive or transit vehicles, and also reducing unsprung weight of rail car.
3. Simple, robust and low-cost brake shoes that are easily replaceable.

With present demands of increasing rail car load, increasing car running speed and improving operational reliability/efficiency, railway wheels are required to withstand more thermal and mechanical load without sacrificing its reliability and safety.

Accordingly, what is needed in the art are new wheel configurations that offer greater thermal tolerance to brake shoe thermal input, increased heat dissipation capacity, enhanced resistances to various types of thermal damages and reduced hot axial deflections.

The applicant's invention is a substantial departure from conventional railway wheels, and the applicant is not aware of any prior art having a similar railway wheel configuration similar to his.

### SUMMARY OF THE INVENTION

One object of the present invention is to provide novel wheel configuration with integrated brake drum that remains substantially contact-free with rail and is dedicated to railway vehicle frictional braking. Such wheel configurations are invented aiming at increasing thermal tolerance and enhancing thermal damage resistances of the wheel, reducing hot axial deflection of the wheel flange and retarding formation of hollow wheel tread.

Another object of the present invention is to provide above-mentioned novel wheel configurations that permit easy wheel manufacture by conventional processes and easy wheel application to the existing railway vehicle requiring minimum modification to the vehicle components.

Another object of the present invention is to provide converted wheel tread braking means and the conversion methods for the existing rail car in order to accommodate the use of the novel wheels.

Other objects and advantages of the present invention can become more apparent to those skilled in the art as the nature of the invention is better understood from the accompanying drawings, as well as detailed descriptions.

### BRIEF DESCRIPTION OF THE DRAWINGS

FIG. 1 is a partial top view of a standard rail car truck that exemplifies the prior art, including a standard railway wheel set and a wheel tread braking system.

FIG. 1A is a partial cross sectional view of the apparatus depicted in FIG. 1 taken along the line 1A-1A, showing a standard railway wheel being engaged with a brake shoe.

FIG. 1B is a partial cross sectional view of the standard railway wheel and the engaging-brake-shoe depicted in FIG. 1A, taken along the line 1B-1B.

FIG. 1B_C is an illustration of hot axial deflection of the wheel shown in FIG. 1B.

FIG. 2 is a partial cross sectional view of one embodiment of the present invention.

FIG. 2_C is an illustration of hot axial deflection of the wheel shown in FIG. 2.

FIG. 3 is a partial cross sectional view of an alternative to the embodiment shown in FIG. 2.

FIG. 3_C is an illustration of hot axial deflection of the wheel shown in FIG. 3.

FIG. 4 is a partial cross sectional view of another alternative to the embodiment shown in FIG. 2.

FIG. 4_C is an illustration of hot axial deflection of the wheel shown in FIG. 4.

### DETAILED DESCRIPTION OF THE DRAWINGS

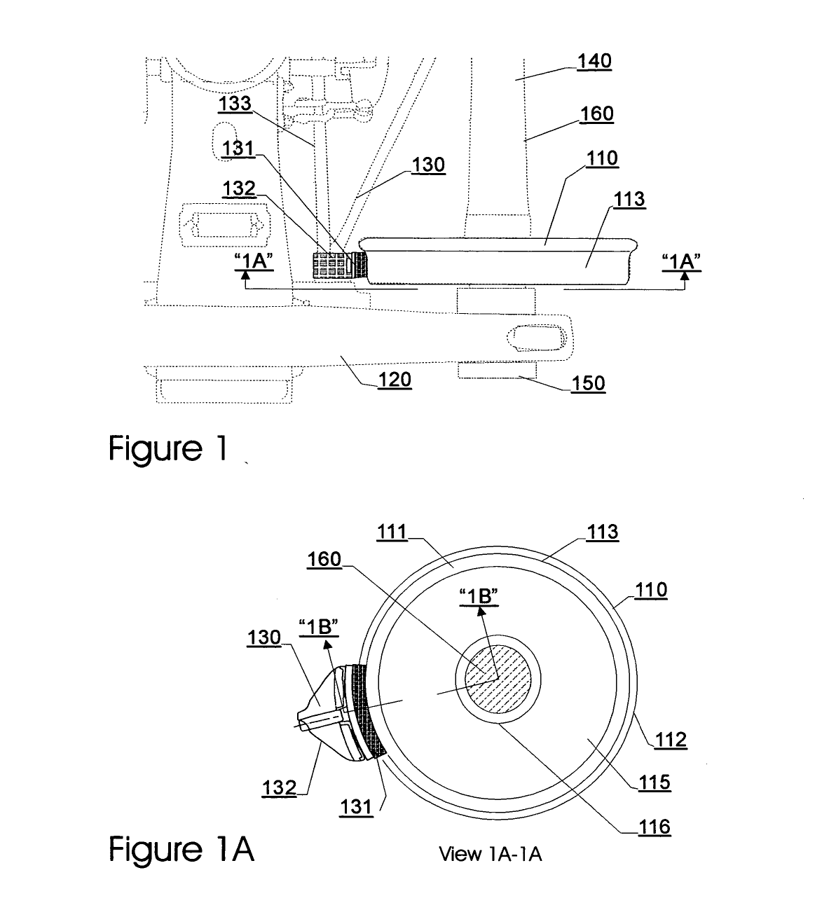

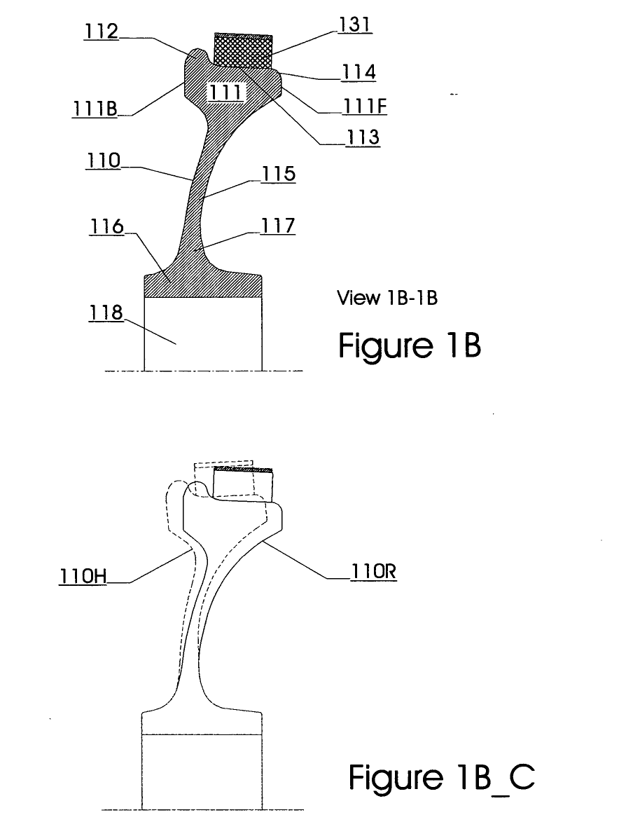

Referring to FIG. 1, FIG. 1A and FIG. 1B, a conventional rail car truck 120 that is typical of the prior art is provided showing a wheel set assembly 140 and a tread brake system 130 in particular.

The wheel set assembly 140 comprises of a pair of wheels 110 and roller bearings 150 that are mounted on opposite ends of an axle 160. The tread brake system 130 comprises of a brake beam 133 activated by an air brake control system, a pair of brake shoe holders 132 mounted near opposite ends of the brake beam 133 and a pair of brake shoes 131 mounted to the brake shoe holders 132. The pair of brake shoe holder 132 is positioned on the brake beam in a way that assures proper brake shoe/wheel tread engagement during tread braking.

As best shown in FIG. 1B, each wheel 110 is provided with an annular wheel rim 111, an annular wheel hub 116, and a substantially radially extended wheel plate 115 that connects integrally the wheel rim 111 and the wheel hub 116. Each wheel rim 111 has two sides, a front side 111F that faces outward once mounted on the axle 160 and a back side 111B that faces inward to another wheel once mounted on the axle 160. Each wheel is provided with a flange 112 that is protruded radially outward from the wheel rim 111 near the back side 111B and a smooth front edge 114 with a substantially large radius.

The outer periphery of the wheel rim 111 forms a wheel tread 113 that rolls on rail track all the times and is engaged with brake shoe 131 substantially radially during tread braking. The essentially cylindrical shaped inner periphery of the wheel hub 116 forms a wheel bore 118 that is created at the center of the wheel hub 116 for mounting to the axle 116. The wheel flanges 112 of the pair of wheels 110 mounted on the same axle 160 help guiding/steering the rail car truck 120 on rail track.

At any given time, the contact between tapered wheel tread 113 and crowned rail head is limited to a coin-size small area. However, under various rail track conditions, the rail/wheel contact points disperse over the entire wheel tread 113, with majority of them falling between center line of the tread and the flange 112. Meanwhile, the brake shoe 131 engages with almost full width of wheel tread 113 during tread braking and consequently the wheel tread 113 suffers from uneven worn out, more wear near flange 112, less wear near the edge 114, forming a hollow wheel tread.

FIG. 1B_C provides an illustration of magnified hot axial deflection of the wheel 110 upon absorption of brake heat during tread braking. The solid line shows profile 110R of the cold standard wheel 110 when it rolls on the rail track. The phantom line shows profile 110H of the heated wheel 110 when it is subjected to severe tread braking.

It is known that the heated wheel rim 111 during tread braking tries to expand radially and is constrained by the colder wheel plate 115 and the even colder wheel hub 116, thereby creating strong internal tensile hoop stresses in the wheel rim 111 and wheel plate 115, generating strong bending stress in the joint area 117 and causing hot axial deflection of the wheel flange 112. The tensile hoop stress in the wheel plate 115 is resisted by the beneficial compressive residual stresses produced by the heat treatment during wheel manufacture. However, the residual stress reversal, either locally or generally, from beneficial compressive hoop stress to tensile hoop stress could occur in the wheel rim 111 under heavy tread braking, leading to catastrophic wheel failures.

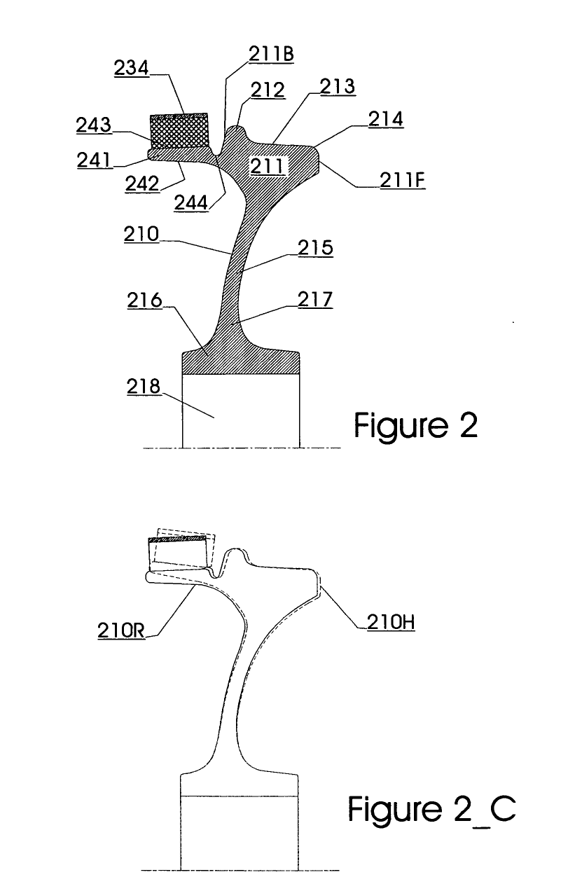

Referring to FIG. 2, one novel wheel configuration 210 of the present invention is shown in a similar manner as the wheel 110 in FIG. 1B. The wheel 210 differs from the wheel 110 by an additional brake drum 241 extending substantially axially from the back side of the wheel rim 211.

The outer surface 243 of the integrated brake drum 241 is tapered similarly to the wheel tread 213 that is favorable for both proper functioning and easy manufacturing of the novel wheel 210.

A stress relief groove 244 of a suitable geometry is created on the outer surface of the integrated brake drum at the transition intermediate the wheel rim 211 and the integrated brake drum 241. The inner surface 242 of the integrated brake drum 241 merges with the wheel back plate contour.

The wheel 210 can be manufactured by any suitable conventional manufacturing processes including but not limited to forging, casting, machining or any combinations of the above-mentioned processes. The brake drum 241 is formed integrally with the wheel 210 during the wheel manufacturing process. The stress relief groove 244 is created by either near net shape casting, hot/cold rolling or a successive conventional machining following the wheel casting or wheel forging.

The wheel 210 is also subjected to similar heat treatment, shot peening, non destructive testing (NDT), chemical and physical analysis and dimensional inspections as the wheels 110 do during the wheel manufacture. Consequently, similar level of compressive residual stresses are developed in the wheel rim 211 as well as in the integrated brake drum 241, which are beneficial for resisting wheel fatigue and thermal wheel failures.

The wheel 210 is made of any suitable material including but not limited to carbon steel, alloy steel, other metal alloys or metal composites.

The novel wheel 210 of the present invention can be used with most of the existing rail car components without any needs for modification. In particular, the novel wheel 210 permits the use of standard wheel tread braking means that is similar to the arrangement shown in FIG. 1. The brake shoe 234 is similar if not identical to the brake shoe 131. Obviously, the pair of brake shoes 234 must be relocated to relatively closer positions and their inclination angle must be altered in order to engage properly with the wheel set equipped with the novel wheels 210. This can be easily achieved by either relocation/reposition of the brake shoe holders on an existing standard rail car brake beam or manufacture of a shortened brake beam with prolonged brake beam extension ends.

The addition of the integrated brake drum 241 avoids direct brake shoe thermal input into the wheel tread 213 and provides additional thermal masses in a relatively thin-walled geometry favorable for efficient air cooling. The altered wheel geometry combined with altered heat input location, lowers the local temperature of the wheel tread 213 and of the wheel rim 211, lowers the overall stress state in the wheel rim 211 as well as in the wheel plate 215 and limits the amount of hot axial deflection in the wheel flange 212. All these changes contribute to greater thermal tolerance of the wheel 210 to brake shoe thermal inputs and greater resistances to the wheel thermal damages when compared to the wheel 110 of the prior art.

FIG. 2_C provides an illustration of magnified hot axial deflection of the wheel 210 upon absorption of brake heat during vehicle frictional braking. The solid line shows profile 210R of the cold novel wheel 210 of the present invention when it rolls on the rail track. The phantom line shows profile 210H of the heated novel wheel 210 when it is subjected to severe frictional braking.

The added integrated brake drum 241 in thin-wall geometry experiences significant hot deflection under heavy brake shoe thermal input. By contrast, the remaining wheel body including wheel rim 211 and wheel plate 215 suffers from lower thermal stresses and exhibits smaller hot axial deflection when compared to the wheel 110 of the prior art.

It should be noted that one two-section brake shoe or two brake shoes, one being engaged with the outer periphery 243 of the brake drum 241 and the other with the wheel tread 213, can be used with the wheel 210 for the purpose of minimizing hot axial deflection of the wheel flange 212.

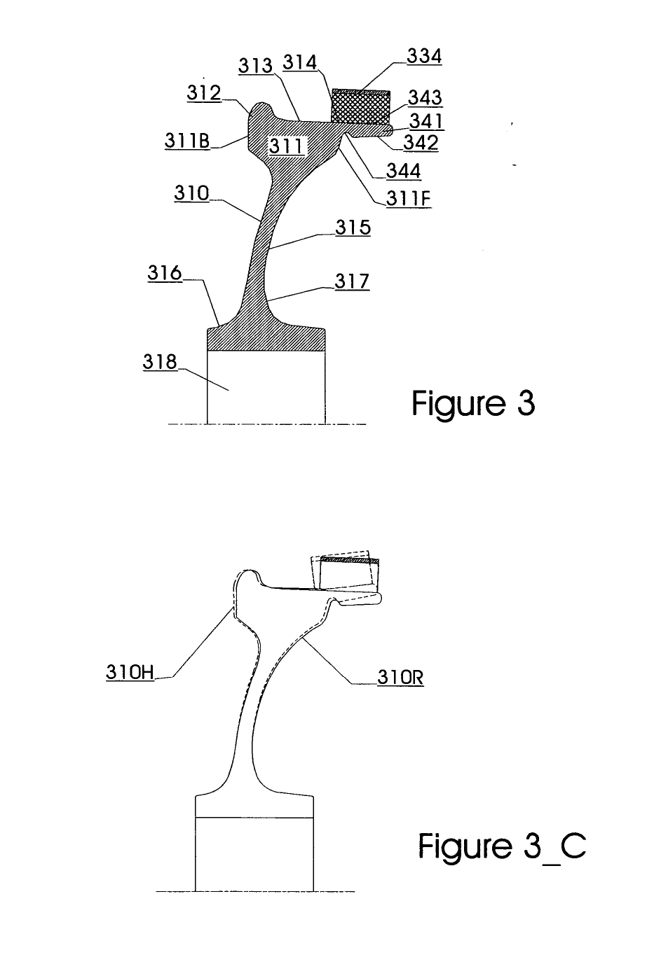

Referring to FIG. 3, an alternative wheel configuration 310 of the present invention is shown in a similar manner as the wheel 210 in FIG. 2.

Instead of integrating a brake drum by the back side of the wheel rim as the wheel 210, the wheel 310 provides an integrated brake drum 341 by the front side of the wheel rim 311. The brake drum 341 has a similar thin-wall configuration as the brake drum 241 in the wheel 210. The outer peripheral surface 343 of the brake drum 341 is formed as a straight projection of the tapered wheel tread 313 while the inner surface 342 of the brake drum 341 takes a substantially cylindrical or slightly tapered shape. A stress relief groove 344 of a suitable geometry is created on the inner surface 342 of the brake drum 341 adjacent to the wheel rim 311.

The brake shoe 334 is positioned so that it can engage with a portion 314 of the wheel tread 313 and the peripheral surface 343 of the brake drum 341 at the same time. The portion 314 of the wheel tread 313, similar to the front edge 114 of the wheel 110, is subjected to less frequent heavy engagement with the rail, and experiences less rail-engaging wear than the rest of the wheel tread 313. The additional brake shoe/wheel tread engagement, however, promotes braking wear in the portion 314 of the wheel tread and makes the wheel tread 313 worn out evenly.

Therefore, apart from similar benefits on the wheel performance as the wheel 210, the wheel 310 does offer additional advantages such as retarding the formation of hollow wheel tread, and distancing brake shoe thermal input further away from the critical wheel flange 312.

The novel wheel 310 of the present invention permits use of existing standard rail truck components with minor modifications such as relocation of brake shoe holder on brake beam.

The wheel 310 is made of any suitable material including but not limited to carbon steel, alloy steel, other metal alloys or metal composites and is manufactured by any suitable conventional manufacturing methods such as forging, casting, machining or any suitable combination of the above.

FIG. 3_C provides an illustration of magnified hot axial deflection of the wheel 310 upon absorption of brake heat during vehicle frictional braking. The solid line shows profile 310R of the cold novel wheel 310 of the present invention when it rolls on rail track. The phantom line shows profile 310H of the heated novel wheel 310 when it is subjected to severe frictional braking. Thanks to enhanced air cooling and extra thermal mass provided by the integrated brake drum 341, the wheel 310 exhibits smaller hot axial deflection when compared with the wheel 110 of the prior arts under the same brake shoe thermal input conditions

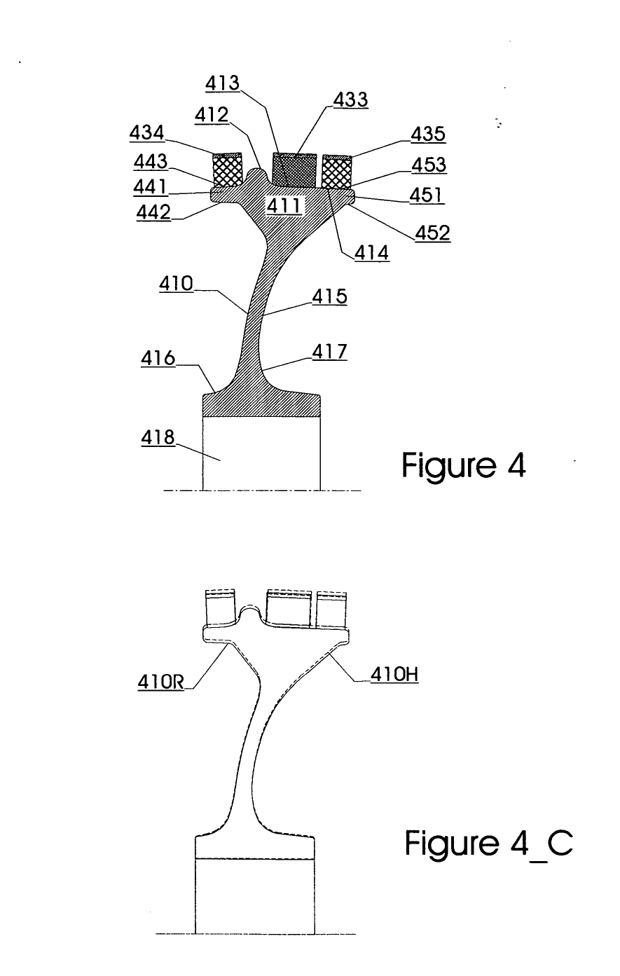

Referring to FIG. 4, another alternative wheel configuration 410 of the present invention is provided. The novel wheel 410 differentiates itself from the wheel 210 or 310 in following aspects:
A. two relatively narrower brake drum 441 and 451 are added by extending the wheel rim 411 by both front side and back side. The integrated brake drum 441 takes similar geometric shape as the brake drum 241 while the integrated brake drum 451 is formed similarly as the brake drum 341;
B. two separate brake shoe 434 and 435 are provided, each being positioned to engage with the peripheral surface of the brake drum 443 and 453 respectively,
C. an additional tread reconditioning shoe 433 with suitable material composition may optionally be disposed together with brake shoe 434 and 435, backed by suitable spring action means. The tread reconditioning shoe 433 helps remove superficial fatigue cracks developed on the wheel tread 413 that may eventually lead to broken wheel.

The ratio of brake shoe working surface between the brake shoe 434 and 435 is pre-determined and controlled so that the amounts of brake shoe thermal inputs into brake drum 441 and 451 will cause negligible hot axial deflection in the wheel flange 412. The divided brake shoe/brake drum arrangement also have enlarged effective heat dissipation surface resulting in improved air cooling performance when compared to single brake shoe arrangements such as the wheel 110, 210 or 310.

However, the novel wheel 410 does require additional brake shoe or special brake shoe set be made in order to accommodate the application of such novel wheel 410.

FIG. 4_C provides an illustration of magnified hot axial deflection of the wheel 410 upon absorption of the brake heat during vehicle frictional braking. The solid line shows profile 410R of the cold novel wheel 410 of the present invention when it rolls on the rail track. The phantom line shows profile 410H of the heated novel wheel 410 when it is subjected to severe frictional braking. As described earlier, negligible hot axial deflection may be obtained under optimized brake shoe thermal input ratio between the brake shoe 434 and 435.

### OTHER GENERAL REMARKS

1. While the present invention is illustrated and described based on an integrally formed wheel structure with integrated brake drum, it is to be understood that the present invention is also applicable for use with other wheel configurations that allows separate brake drum be attached to wheel rim therefore making the brake drum replaceable during service life of the wheel.
2. A plurality of radially oriented holes in essentially round shape and in suitable size may be created in the bottom of the stress relief groove 244/344 and/or in the brake drum 241/341/441/451, for the purpose of reducing thermal stress, promoting air cooling and improving frictional braking performance.
3. The transition between the brake drum and the wheel rim where the stress relief grooves locate may be prolonged and formed with a curved cross sectional shape to further reduce the effect of stress concentration in that intermediate region.
4. Present tread brake system can be easily altered so that brake shoe engages with inner peripheral surface of brake drum instead of outer peripheral surface, or engages with both surfaces of the brake drum.
5. Non brake shoe engaging surface of the brake drum, for example inner surface 242 or 342 of the brake drum 241 or 341 can be formed in a corrugated, grooved or threaded geometry for the purpose of promoting effective air cooling.
6. While the present invention is illustrated and described based on configuration of standard tread brake shoe, it is to be understood that the present invention is also applicable for use with other wheel configurations/geometry that allows other non standard alternative tread brake shoes be used.
7. While the present invention is illustrated and described based on particular type of railway wheel with parabolic wheel plate and being made of cast steel, it is to be understood that the present invention is also applicable for use with other types of wheel plate configurations/geometry and made of other suitable types of material or processes.
8. While the novel wheel and other modified auxiliary components is configured for rail car application, it is to be understood that the present invention is also be applicable for use with other types of ground transportation vehicle or heavy machinery.

Other advantages of the present invention will become more fully apparent and understood with reference to the appended drawings and claims.

What is claimed is:

1. A railway wheel for use with a railway vehicle brake mechanism, each said wheel comprising:
a hub with an axial bore;
an axially elongated annular tread defining a rim being generally concentric with said bore, said tread being engaged with a rail;
a plate extending generally radially outward from said hub to said rim;
a flange projecting radially outward from said rim;
and at least one annular and generally axially elongated brake drum being disposed adjacent to said rim and generally concentric with said bore, said brake drum remaining substantially contact-free with said rail;
said railway vehicle brake mechanism provided for each said wheel comprising:
brake elements;
a brake-element-engaging means that carries said brake elements and operable to engage brake elements with the peripheral surface of said wheel to brake rotation of said wheel thereby defining brake-element-engaged wheel surface;
said brake-element-engaged wheel surface including at least partially the peripheral surface of said brake drum, thereby dividing the peripheral surface of said brake drum into engaged drum surface and unengaged drum surface.

2. The railway wheel for use with the railway vehicle brake mechanism as recited in claim 1, wherein said wheel is an integrally formed structure and said brake drum is an extension of said rim thereby defining a transition between said brake drum and said rim.

3. The railway wheel for use with the railway vehicle brake mechanism as recited in claim 2, wherein the transition between said brake drum and said rim includes at least one grooved or one curved surface area.

4. The railway wheel for use with the railway vehicle brake mechanism as recited in claim 1, wherein the unengaged drum surface is formed with corrugation or undulation.

5. The railway wheel for use with the railway vehicle brake mechanism as recited in claim 1, wherein the engaged drum surface is within the outer peripheral surface of the brake drum and the brake element is applied substantially radially to the engaged drum surface.

6. The railway wheel for use with the railway vehicle brake mechanism as recited in claim 5, wherein the brake elements are applied to both the tread and the outer peripheral surface of the brake drum.

7. The railway wheel for use with the railway vehicle brake mechanism as recited in claim 1, wherein
the engaged drum surface is within the outer peripheral surface of the brake drum;
the brake elements are tread brake shoes;
the brake-element-engaging-means is a converted-railway-tread-braking means that carries said tread brake shoes and engages at least one of said tread brake shoes with the engaged drum surface, said converted-railway-tread-braking means is converted from a standard-railway-tread-braking means that applies the brake shoes only to the tread.

8. A method for improving performance and reliability of a railway wheel being used as a frictional brake component in a railway vehicle, the method comprising,
forming integrally said railway wheel in one structure, said railway wheel comprising,
a hub with an axial bore;
an axially elongated annular tread defining a rim being generally concentric with said bore, said tread being engaged with a rail;
a plate extending generally radially outward from said hub to said rim;
a flange projecting radially outward from said rim;
and at least one annular and generally axially elongated brake drum being disposed adjacent to said rim and generally concentric with said bore, said brake drum remaining substantially contact-free with said rail;
providing a railway vehicle brake mechanism for each said wheel, said railway vehicle brake mechanism comprising,
brake elements;
a brake-element-engaging means that carries said brake elements and operable to engage brake elements with the peripheral surface of said wheel to brake rotation of said wheel thereby defining brake-element-engaged wheel surface;
said brake-element-engaged wheel surface including at least partially the peripheral surface of said brake drum, thereby dividing the peripheral surface of said brake drum into engaged drum surface and unengaged drum surface.

9. The method for improving performance and reliability of a railway wheel being used as a frictional brake component in a railway vehicle, as recited in claim 8, wherein the brake drum surface has at least one grooved or curved area within the transition between the brake drum and the rim.

10. The method for improving performance and reliability of a railway wheel being used as a frictional brake component in a railway vehicle, as recited in claim 8, wherein the unengaged drum surface is formed with corrugation or undulation.

11. The method for improving performance and reliability of a railway wheel being used as a frictional brake component in a railway vehicle, as recited in claim 8, wherein the engaged drum surface is within the outer peripheral surface of the brake drum and the brake element is applied substantially radially to the engaged drum surface.

12. The method for improving performance and reliability of a railway wheel being used as a frictional brake component in a railway vehicle, as recited in claim 8, wherein
the wheel has at least one back-side brake drum extending axially from the side of the rim adjacent to the flange;
the brake-element-engaged wheel surface includes at least two areas located on different side of the flange, said one of the two areas being the peripheral surface of the back-side brake drum, said two areas having braking thermal inputs into the wheel, the ratio of the braking thermal inputs from said two areas are selected and controlled to minimize hot axial deflection of said wheel.

13. The method for improving performance and reliability of a railway wheel being used as a frictional brake component in a railway vehicle, as recited in claim 8, wherein
the wheel has at least one front-side brake drum extending axially from one of the two sides of the rim that is relatively far away from the flange than the other side of the rim;
the brake-element-engaged wheel surface includes engaged drum surface and a edge portion of the tread adjacent to the engaged drum surface, the edge portion of the tread being subjected to less rail-engaging wear than the rest of the tread, the edge portion of the tread being subjected to additional braking wear when being engaged with the brake elements, the combined effect from said rail-engaging wear and said braking wear retarding the formation of hollow wheel tread.

14. The method for improving performance and reliability of a railway wheel being used as a frictional brake component in a railway vehicle, as recited in claim 8, wherein
the engaged drum surface is within the outer peripheral surface of the brake drum;
the brake elements are tread brake shoes;
the brake-element-engaging means is a converted-railway-tread-braking means that carries said tread brake shoes and engages at least one of said tread brake shoes with the engaged drum surface, said converted-railway-tread-braking means is converted from a standard-railway-tread-braking means that applies the brake shoes only to the tread.

15. The method for improving performance and reliability of a railway wheel being used as a frictional brake component in a railway vehicle, as recited in claim 8, wherein the railway vehicle brake mechanism has at least one abrasive element that is carried by the brake-element-engaging means and is operable to engage with the tread for the purpose of reconditioning the tread.
